(19) United States
(12) Patent Application Publication
(10) Pub. No.: US 2006/0158679 A1
(43) Pub. Date: Jul. 20, 2006

(54) Computer/printer

(76) Inventor: Jack Gilbert Hilden, Pleasant View, UT (US)

Correspondence Address: Jack Hilden, 3945 N 650 W, Pleasant View, UT, 84414, US

(21) Appl. No.: 11/111,213

(22) Filed: Apr. 22, 2005

Related U.S. Application Data
(60) Provisional application No. 60/645,912, filed on Jan. 20, 2005.

(51) Int. Cl. G06F 3/12

(52) U.S. Cl. 358/1.15

(57) ABSTRACT

This invention simplifies typical computer stations by eliminating one metal box, by eliminating the wires connecting the computer to the printer and by simplifying the communication electronics between the printer and the central processing unit. Duplicated controls currently contained on the printer control panel and in the computer are eliminated or combined. This is accomplished by incorporating required central processing unit and input/output functions into the printer.

### BACKGROUND OF THE INVENTION

The inventor is a chemical engineer with a MBA who was active in rocket motor development and production until his retirement in 1994. As such he was heavily involved in the early introduction of computerized information systems into technical and business organizations. Since his retirement he has used personal computers and laptops for personal use. He has remained computer literate but has not followed the latest computer improvements in detail. He has upgraded his computer equipment every couple years and currently has three computer stations of varying vintage and complexity. He spends his winters in a senior retirement community and has assisted friends who are less computer literate in solving problems with their computers.

Over the past few years two trends in the computer industry have caught his attention. The first trend is the rapidly increasing power and complexity of personal computers. This power and complexity goes way beyond the needs of many casual computer users and causes many problems as they attempt to use their computers. The second trend is the increasing capabilities of modern printers. All-in-one printers now can print, copy, scan, FAX and even process digital photographs. They have view screens and fairly complex control panels.

As he observed these trends and worked with his friends, problems in using the computers seemed to increase. During one week in March 2005 the inventor was involved in the following problems:

A) An artist friend was having difficulty changing the captions on his pencil drawings. The drawings were stored on a compact disk (CD) formatted by a commercial agency for him. He found that he could change the captions and print the modified drawings but could not store the revisions. Use of Save As allowed storage of his revised drawings.

B) The handicap chairperson for a small golf group could not bring up her handicap management program without receiving an error notification which immediately closed the program. The inventor felt that the memory might be overloaded and attempted to remove some of the programs operating in the background. He was not successful and the hard drive had to be restored.

C) A friend lost track of several photograph files. Her photo processing program took her automatically to a “favorites” location after the “Open” command. Somehow reference to the missing files disappeared from the “favorites” location. A search operation located the files which were reinstated in the “favorites” location. This corrective action was beyond her capabilities.

D) A stranger could obtain access to the Internet from his laptop but then could not accomplish anything such as getting access to his email. He also had lost all of the icons on his desktop. The inventor could not help him.

5) In another instance the inventor struggled with a printer for several minutes before he realized that he had to control FAX preparation from the computer if he wanted to include a cover sheet with the FAX. Duplicated controls on the printer and in the computer increase complexity and cause confusion.

One morning it occurred to the inventor that a modest increase in the capabilities of a modern printer along with a straightforward modification of its view screen and control panel might allow complete elimination of the central processing unit (CPU) box. If the printer were able to provide word processing, spreadsheet, data base, additional input/output functions and other desired central processing unit (CPU) functions the computer station could be simplified, made more user friendly and less costly. The result was the invention described in the next sections. This invention will not solve all of the problems like those described above but it might be a first step in simplifying computer stations for those of us who don't need all of the capabilities being introduced by the computer and software industries.

### BRIEF SUMMARY OF THE INVENTION

The following changes to a modern computer printer are required to implement this invention. Electronics are added to the printer to provide word processing, spreadsheet, data base and other desired computer capabilities. The view screen is replaced with a standard computer monitor and the control panel is replaced by a standard computer keyboard and mouse. Provisions for additional input and output capabilities such as Internet access, diskettes, CD, DVD and speakers are added.

The result is a simplified computer station that has eliminated one box, some of the wiring and duplicated controls.

### DETAILED DESCRIPTION OF THE INVENTION

This invention increases the capabilities of a modern computer printer by (1) incorporating some of the capabilities contained in the central processing unit (CPU) box of a modem personal computer into the printer, (2) replacing the view screen and control panel with a standard computer monitor, a standard computer keyboard plus a mouse and (3) including provisions for additional input and output capabilities such as Internet access, diskettes, CD, DVD and speakers.

Modern printers, especially those that contain scan, fax, print and photo processing capabilities, have begun to contain many of the capabilities of personal computers. This invention takes advantages of these capabilities by modifying some of them and adding other features of the computer to make possible the elimination of the central processing unit (CPU) box for typical computer stations. The main external features of the printer modified in this invention are the view screen and the control panel. The view screen is replaced with a standard computer monitor and the control panel is replaced by a standard computer keyboard and mouse. Provisions for additional input and output capabilities such as Internet access, diskettes, CD, DVD and speakers are added. Electronics are added to the printer to provide word processing, spreadsheet, data base and other desired computer capabilities.

This invention simplifies typical computer stations by eliminating one metal box, by eliminating the wires connecting the computer to the printer and by simplifying the communication electronics between the printer and the computer. Duplicated controls currently contained on the printer control panel and in the computer are eliminated or combined. Costs should be reduced. Combining the electronic functions of the printer and computer may also make some of them faster and/or more reliable.

### DISTINGUISHING FEATURES OF THIS INVENTION

This invention is distinguished from modern desktop printers in that it does not have to be connected to a computer to prepare letters, spread sheets and other computer products for printing. This invention is distinguished from a modern computer in that it does not have to be connected to a printer to print the products of the computer.

### MODE CONTEMPLATED FOR CARRYING OUT THIS INVENTION

All of the skills needed to implement this invention exist in most companies that currently develop and produce computers and/or printers. This invention can probably best be carried out by one of these companies. The skills contained in one of these companies could allow successful making and using this invention with little if any experimentation.

1) A printer that has, in addition to its normal capabilities, capabilities such as word processing, spreadsheet preparation, data base activities, and input/output functions that are normally provided by the central processing unit box.

2) A functional computer station which requires no central processing unit box because required central processing unit and input/output functions have been incorporated into the printer.
